(19) United States
(12) Patent Application Publication
(10) Pub. No.: US 2011/0265079 A1
(43) Pub. Date: Oct. 27, 2011

(54) ELECTRONIC DEVICE AND METHOD FOR COMPUTING OPTIMAL PARAMETERSOF AN EQUALIZATION FILTER

(75) Inventors: CHENG-HSIEN LEE, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/037,112

(22) Filed: Feb. 28, 2011

(30) Foreign Application Priority Data
Apr. 21, 2010 (TW) 99112574

(51) Int. Cl. G06F 17/50; G06F 9/445

(52) U.S. Cl. 717/174; 703/3

(57) ABSTRACT

In an electronic device and a method for computing optimal parameters of an equalization filter, an output file, which comprises times and voltages of data points that represent a signal, of electronic circuit simulation software is loaded, and is read using the installed post-processing software. A time interval of outputs of the signal is obtained by selecting an output type of the signal. A parameter file which includes several sets of equalization parameters of the equalization filter is received, to select optimal equalization parameters for the equalization filter from the several sets of equalization parameters according to the times, the voltages, and the time interval, using a parameter formula y(n)=a*x(n)−b*x(n−1)−c*x(n−2).

### BACKGROUND

1. Technical Field

Embodiments of the present disclosure generally relate to simulation and analysis of electrical signals, and more particularly to an electronic device and a method of computing optimal parameters for an equalization filter.

2. Description of Related Art

A low-pass filter is a filter that passes low-frequency signals but attenuates (e.g., reduces amplitude) of a signal with a frequency higher than a predetermined cutoff frequency. Most signal channels are low-pass filters. Thus, when signals pass through a signal channel from a sender to a receiver, the signals may be weakened, for example, like illustrated in FIG. 1.

In order to solve the problem of signals being weakened by signal channels, an equalization filter can be used. The equalization filter is a filter designed to compensate for the unequal frequency response of other signal processing circuits or systems. Using the equalization filter, the signals passing through a signal channel can be compensated, like illustrated in FIG. 2.

When using the equalization filter to compensate the signals, the parameter settings of the equalization filter are very important. Computing optimal parameters for the equalization filter is a problem demanding solutions.

### BRIEF DESCRIPTION OF THE DRAWINGS

FIG. 1 is a schematic diagram illustrating a signal passing through a signal channel.

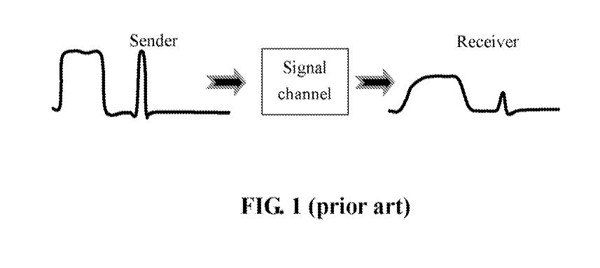

FIG. 2 is a schematic diagram illustrating compensating the signal which passes through the signal channel in FIG. 1.

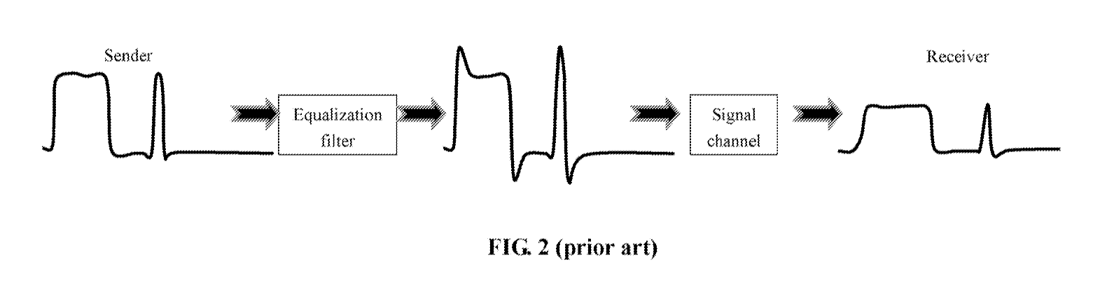

FIG. 3 is a block diagram illustrating an electronic device, according to some embodiments of the present disclosure.

FIG. 4 is a block diagram illustrating function modules of a system of computing optimal parameters for an equalization filter included in the electronic device of FIG. 3, according to some embodiments of the present disclosure.

FIG. 5 is a flowchart illustrating a method of computing optimal parameters for an equalization filter, according to some embodiments of the present disclosure.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may be comprised of connected logic units, such as gates and flip-flops, and may be comprised of programmable units, such as programmable gate arrays or processors. The modules described herein may be implemented as either software and/or hardware modules and may be stored in any type of computer-readable medium or other computer storage device.

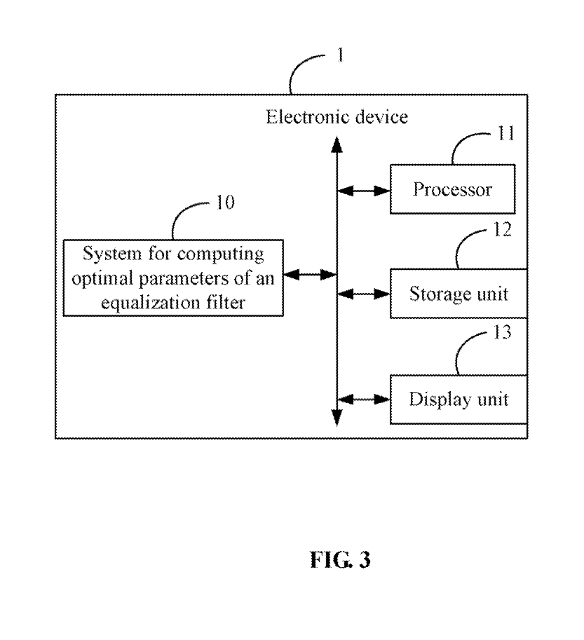

FIG. 3 is a block diagram illustrating an electronic device 1, according to some embodiments of the present disclosure. The electronic device 1 includes components of a system 10 for computing optimal parameters of an equalization filter, a processor 11, a storage unit 12, and a display unit 13. These components 10˜13 communicate over one or more communication buses or signal lines. The electronic device 1 can be any electronic device, including but not limited to a computer, a server, or a personal digital assistant (PDA), for example. It should be appreciated that the electronic device 1 may have more or fewer components than shown in FIG. 3, or a different configuration of components. The various components shown in FIG. 3 may be implemented in hardware, software or a combination thereof, including one or more signal processing and/or application specific integrated circuits.

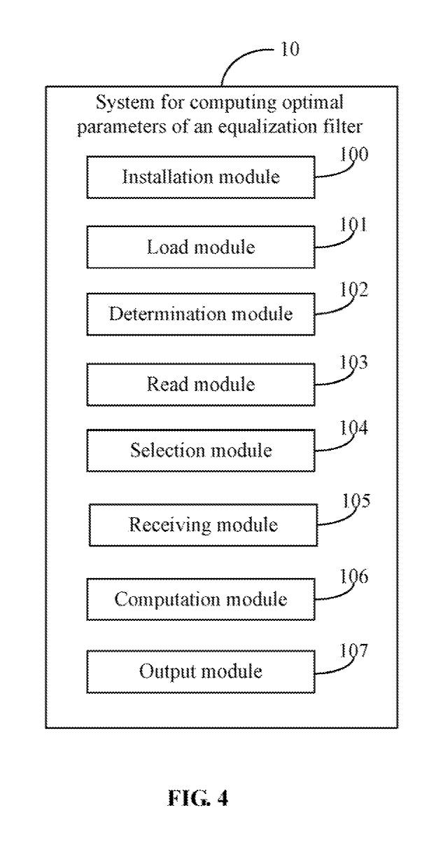

The system 10 includes a plurality of function modules (see below descriptions referring to FIG. 4), to compute optimal parameters for an equalization filter.

The function modules of the system 10 may include one or more computerized codes in the form of one or more programs that are stored in the storage unit 12. The storage unit 12 may include high speed random access memory and may also include non-volatile memory, such as one or more magnetic disk storage devices, flash memory devices, or other non-volatile solid state memory devices. The one or more computerized codes of the system 10 includes instructions that are executed by the processor 11, to provide functions for the function modules of the system 10.

FIG. 4 is a block diagram illustrating the function modules of the system 10, according to some embodiments of the present disclosure. The function modules of the system 10 may include an installation module 100, a load module 101, a determination module 102, a read module 103, a selection module 104, a receiving module 105, a computation module 106, and an output module 107.

The installation module 100 installs a plurality of post-processing software into the electronic device 1. It may be appreciated that, electronic circuit simulation software uses mathematical models to replicate the behavior of an actual electronic device or circuit to generate an output file. The output file includes times and voltages of data points that represent an electronic/electrical signal (hereinafter “the signal”). The signal may indicative of a signal outputted from a circuit from a printed circuit board, for example. The post-processing software can analyze and process the output file of the electronic circuit simulation software.

The load module 101 loads an output file of the electronic circuit simulation software. The output file may be an ALLEGRO format, an HSPICE format, an ADS format, or a SPEED format.

The determination module 102 determines a format of the output file, and determines whether the installed post-processing software is able to read the output file according to the format of the output file, and informs the installation module 100 to install new post-processing software, which is able to read the output file, into the electronic device 1 if the installed post-processing software is not able to read the output file. It is understood that, the output files generated by different electronic circuit simulation software have different formats. For example, the output file generated by the electronic circuit simulation software ALLEGRO PCB SI may be an ALLEGRO format or an HSPICE format. The output file generated by the electronic circuit simulation software ADS may be an ADS format or an HSPICE format. The output file generated by the electronic circuit simulation software SPEED is a SPEED format. However, the post-processing software cannot read all formats of output files.

The read module 103 reads the times and voltages of the data points that represent the signal from the output file using the installed post-processing software.

The selection module 104 selects an output type of the signal to obtain a time interval of outputs of the signal, that is, how often the signal is outputted. The output type may be a peripheral component interconnect (PCI) Express signal type or a universal serial bus (USB) signal type, for example.

The receiving module 105 receives a parameter file which includes several sets of equalization parameters of the equalization filter.

The computation module 106 selects optimal equalization parameters for the equalization filter from the several sets of equalization parameters by computation according to the times, the voltages, the time interval and a parameter formula y(n)=a*x(n)−b*x(n−1)−c*x(n−2). In the parameter formula, a, b, and c are the equalization parameters, x(n), x(n−1), and x(n−2) indicate three continuous signals represented by the data points of the times and the voltages, and y(n) indicates a result of the signal x(n) after passing through the equalization filter. The computation module 106 substitutes each set of equalization parameters into the parameter formula, computes a y(n) corresponding to each set of equalization parameters, and selects a set of equalization parameters, which the y(n) corresponds to and makes the signal x(n) have minor errors after passing through a signal channel, as the optimal equalization parameters.

The output module 108 outputs the optimal equalization parameters on the display unit 13 of the electronic device 1.

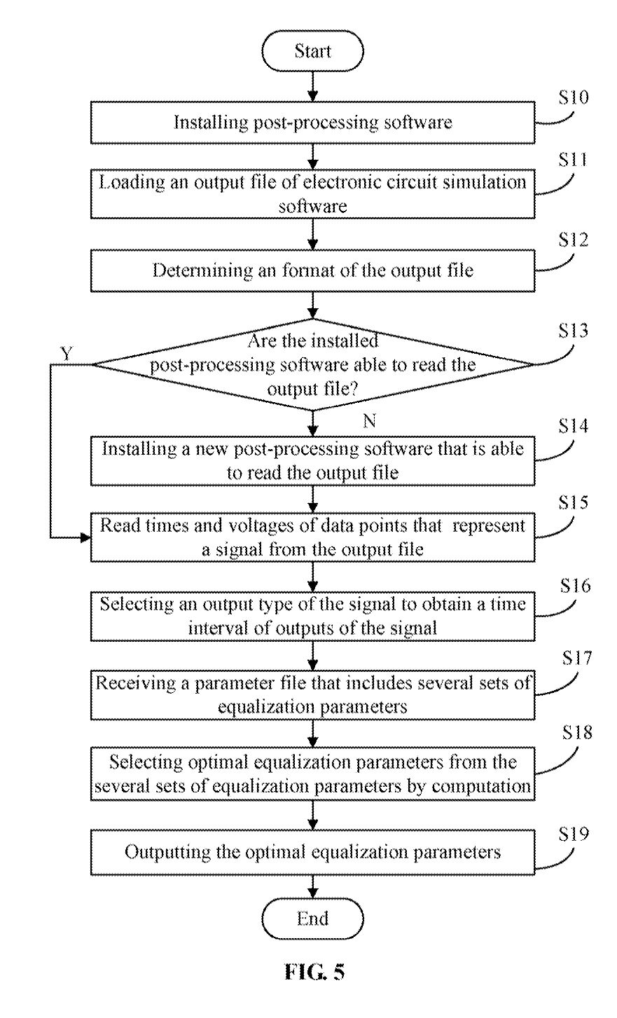

FIG. 5 is a flowchart illustrating a method of computing optimal parameters for an equalization filter, according to some embodiments of the present disclosure. The method being performed by execution of computer readable program code by the processor 11 of the electronic device 1. Depending on the embodiment, additional blocks in the flow of FIG. 5 may be added, others removed, and the ordering of the blocks may be changed.

In block S10, the installation module 100 installs post-processing software into the electronic device 1.

In block S11, the load module 101 loads an output file of electronic circuit simulation software. The output file includes times and voltages of data points that represent a signal. The output file may be an ALLEGRO format, an HSPIECE format, an ADS format, or a SPEED format.

In block S12, the determination module 102 determines a format of the output file.

In block S13, the determination module 102 determines whether the installed post-processing software is able to read the output file according to the format of the output file. Block S14 is implemented if the installed post-processing software is not able to read the output file. Otherwise, block S15 is implemented if the installed post-processing software is able to read the output file

In block S14, the installation module 100 is informed to install new post-processing software, which is able to read the output file, into the electronic device 1.

In block S15, the read module 103 reads the times and the voltages of the data points that represent the signal from the output file using the installed post-processing software.

In block S16, the selection module 104 selects an output type of the signal to obtain a time interval of outputs of the signal. The output type may be a peripheral component interconnect (PCI) Express signal type or a universal serial bus (USB) signal type, for example.

In block S17, the receiving module 105 receives a parameter file which includes several sets of equalization parameters of the equalization filter.

In block S18, the computation module 106 selects optimal equalization parameters for the equalization filter from the several sets of equalization parameters by computation according to the times, the voltages, the time interval, and a parameter formula y(n)=a*x(n)−b*x(n−1)−c*x(n−2). In the parameter formula, a, b, and c are the equalization parameters, x(n), x(n−1), and x(n−2) indicates three continuous signals represented by the data points of the times and the voltages. y(n) indicates a result of the signal x(n) after passing through the equalization filter. The computation module 106 substitutes each set of equalization parameters into the parameter formula, computes a y(n) corresponding to each set of equalization parameters, and selects a set of equalization parameters, which the y(n) corresponds to and makes the signal x(n) have minor errors after passing through a signal channel, as the optimal equalization parameters.

In block S19, the output module 108 outputs the optimal equalization parameters on the display unit 13 of the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for computing optimal parameters of an equalization filter, the method being performed by execution of computer readable program code by a processor of an electronic device, the method comprising:
loading an output file of electronic circuit simulation software, wherein the output file comprises data points that represent an electronic signal;
reading the data points of the electronic signal from the output file using installed post-processing software of the electronic device, the data points comprising time and voltages of the electronic signal;
selecting an output type of the electronic signal to obtain a time interval of outputs of the electronic signal;
receiving a parameter file which includes several sets of equalization parameters of the equalization filter;
selecting optimal equalization parameters for the equalization filter from the several sets of equalization parameters according to the times, the voltages, the time interval, and a parameter formula y(n)=a*x(n)−b*x(n−1)−c*x(n−2), wherein a, b, and c are the equalization parameters, x(n), x(n−1), and x(n−2) indicates three continuous signals represented by the data points of the times and the voltages, y(n) indicates a result of the signal x(n) after passing through the equalization filter; and
outputting the optimal equalization parameters on a display unit of the electronic device.

2. The method as described in claim 1, further comprising:
determining whether the installed post-processing software is able to read the data points of the electronic signal from the output file according to a format of the output file; and
installing new post-processing software that is able to read the data points of the electronic signal from the output file into the electronic device, upon the condition that the installed post-processing software is not able to read the output file.

3. The method as described in claim 1, wherein the format of the output file is one of an ALLEGRO format, an HSPIECE format, an ADS format, and a SPEED format.

4. The method as described in claim 1, wherein the output type of the signal is a PCI Express signal type or a USB signal type.

5. The method as described in claim 1, wherein the optimal equalization parameters are the set of equalization parameters, which the y(n) corresponds to and makes the signal x(n) having minor error after passing through a signal channel.

6. A non-transitory storage medium having stored thereon instructions that, when executed by a processor, cause the processor to perform a method for computing optimal parameter of an equalization filter, comprising:
loading an output file of electronic circuit simulation software, wherein the output file comprises data points that represent an electronic signal;
reading the data points of the electronic signal from the output file using installed post-processing software of the electronic device, the data points comprising time and voltages of the electronic signal;
selecting an output type of the electronic signal to obtain a time interval of outputs of the electronic signal;
receiving a parameter file which includes several sets of equalization parameters of the equalization filter;
selecting optimal equalization parameters for the equalization filter from the several sets of equalization parameters according to the times, the voltages, the time interval, and a parameter formula y(n)=a*x(n)−b*x(n−1)−c*x(n−2), wherein a, b, and c are the equalization parameters, x(n), x(n−1), and x(n−2) indicates three continuous signals represented by the data points of the times and the voltages, y(n) indicates a result of the signal x(n) after passing through the equalization filter; and
outputting the optimal equalization parameters on a display unit of the electronic device.

7. The non-transitory storage medium as described in claim 6, wherein the method further comprises:
determining whether the installed post-processing software is able to read the data points of the electronic signal from the output file according to a format of the output file; and
installing new post-processing software that is able to read the data points of the electronic signal from the output file into the electronic device, upon the condition that the installed post-processing software is not able to read the output file.

8. The non-transitory storage medium as described in claim 6, wherein the format of the output file is one of an ALLEGRO format, an HSPIECE format, an ADS format, or a SPEED format.

9. The non-transitory storage medium as described in claim 6, wherein the output type of the signal is a PCI Express signal type or a USB signal type.

10. The non-transitory storage medium as described in claim 6, wherein the optimal equalization parameters are the set of equalization parameters, which the y(n) corresponds to and makes the signal x(n) having minor error after passing through a signal channel.

11. An electronic device, comprising:
at least one processor;
storage unit;
a display unit;
one or more programs that are stored in the storage unit and are executed by the at least one processor, the one or more programs comprising:
a load module to load an output file of electronic circuit simulation software, wherein the output file includes data points that represent an electronic signal;
a read module to read the data points of the electronic signal from the output file using installed post-processing software of the electronic device, the data points comprising time and voltages of the electronic signal;
a selection module to select an output type of the electronic signal to obtain a time interval of outputs of the electronic signal;
a receiving module to receive a parameter file which includes several sets of equalization parameters of an equalization filter;
a computation module to select optimal equalization parameters for the equalization filter from the several sets of equalization parameters according to the times, the voltages, the time interval, and a parameter formula y(n)=a*x(n)−b*x(n−1)−c*x(n−2), wherein a, b, and c are the equalization parameters, x(n), x(n−1), and x(n−2) indicates three continuous signals represented by the data points of the times and the voltages, and y(n) indicates a result of the signal x(n) after passing through the equalization filter; and
an output module to output the optimal equalization parameters on the display unit.

12. The electronic device as described in claim 11, wherein the one or more programs further comprises:
a determination module to determine a format of the output file, determine whether the installed post-processing software is able to read the data points of the electronic signal from the output file, according to the format of the output file; and
an installation module to install new post-processing software that is able to read the data points of the electronic signal from the output file into the electronic device, upon the condition that the installed post-processing software is not able to read the output file.

13. The electronic device as described in claim 11, wherein the format of the output file is one of an ALLEGRO format, an HSPIECE format, an ADS format, or a SPEED format.

14. The electronic device as described in claim 11, wherein the output type of the signal is a PCI Express signal type or a USB signal type.

15. The electronic device as described in claim 11, wherein the optimal equalization parameters are the set of equalization parameters, which the y(n) corresponds to and makes the signal x(n) having minor error after passing through a signal channel.
